(19) United States
(12) Patent Application Publication
(10) Pub. No.: US 2010/0005941 A1
(43) Pub. Date: Jan. 14, 2010

(54) Apparatus for Introducing Weakening Cuts in a Film or Skin

(75) Inventor: Thorsten Schueppstuhl, Dortmund (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: KraussMaffei Technologies GmbH, Munchen (DE)

(21) Appl. No.: 12/374,014

(22) PCT Filed: Mar. 14, 2007
(86) PCT No.: PCT/EP07/52412

§ 371 Date: Jan. 15, 2009

(30) Foreign Application Priority Data
Jul. 21, 2006 (DE) 102006034287.9

(51) Int. Cl. B31B 1/25

(52) U.S. Cl. 83/879

(57) ABSTRACT

The invention relates to an apparatus for introducing weakening cuts in a film or skin (24) containing a cutting knife (12) and a support (18) arranged in opposition to the cutting knife, wherein the film or skin can be placed between the support and the cutting knife and borne by the support, and the cutting knife is movable relative to the film or skin. In order to ensure a defined residual wall thickness, the invention proposes that the distance between the cutting knife and the support in the direction of the cutting axis (19) can be designed to be kept constant by a device.

The present invention relates to an apparatus for introducing weakening cuts in a film or skin according to the preamble of claim 1.

Certain applications require the introduction of weakening cuts in flat elements to define, for example, a desired breaking point. One application involves the manufacture of instrument panels for motor vehicles with an integrated airbag, whereby the instrument panel breaks up at the designated area, in particular the weakening points, when the airbag is released, so that the airbag is able to emerge. The term “film” or “skin” as used in the present application relates to plastic skins, films or respective flat workpieces, in which the presence of a cut in the material is targeted so as to establish a defined residual wall thickness regardless of the possibly locally fluctuating wall thickness as well as tolerances of a robot-guided movement of tool in relation to workpiece. Especially, when introducing a weakening in the skins of instrument panels of automobiles in the area of the airbag, which are considered safety structures, a high precision of the cut, a high process reliability, and a good process documentation is of great importance.

A known apparatus for introducing such weakening cuts is shown schematically in FIG. 7. A cutting knife 102 of a respective cutting apparatus 100 is hereby guided across a support table 108 which supports a workpiece 110 to be weakened along a certain line. As a result of the distance of the tip of the cutting knife 102 to the support table 108, a cut is made in the workpiece as the cutting knife 102 is moved, whereby a residual wall thickness remains which is designated by reference sign 112. In the present case, the cutting knife 102 can be moved by a servomotor 104 and a spindle drive 106 in a direction of the cutting axis towards the support table and away from the support table. A sensor 118 is used to monitor and control the cutting depth of the cutting tool by measuring the distance (reference sign 116) to the metallic supporting table 108. The geometric relation (reference sign 114) between sensor signal and residual wall thickness is referenced in the preliminary stage of the process, for example by a one-time calibration process. The received signal may in turn be used for controlling the executed cut or for controlling the cutting depth during the cutting operation.

The main shortcoming of this arrangement is the offset disposition of the sensor in relation to the cutting axis. Especially when three-dimensional cutting contours are involved, this spacing causes determination of faulty distance values between cutting knife tip and support table, which do not reflect the actual situation at the cutting tool. Such possibly faulty measuring values do not allow execution of a respective compensation movement so that the cuts cannot be implemented with sufficient process reliability.

It is an object of the present invention to provide an apparatus of this generic type which is able to precisely provide the wanted weakening with a predefined residual wall thickness.

This object is solved by the features set forth in claim 1.

A core idea of the present invention resides accordingly in the provision of a device which allows implementation of a constant distance between the cutting knife and a support along the cutting axis. When the distance between the support and the cutting knife is constant and the film rests continuously against the support, the presence of a constant residual wall thickness is inevitably realized.

The device may hereby basically be constructed in two ways.

One approach is characterized by providing a mechanical coupling, in particular a rigid mechanical coupling, between the cutting knife and the support. As a consequence, support and cutting knife are quasi connected to one another directly or indirectly via a mechanical construction, wherein—except for elastic effects—no change in distance can occur between both relevant parts. Such a coupling may be realized by means of a bracket for example which directly or indirectly connects the cutting knife and the support. It is also appropriate to provide a device which ensures a continuous support of the skin or film upon the support. Such a device may be realized by means of an elastic element, for example a spring, which maintains for example the combination of support and cutting knife under tension against the skin or film in one direction so that the skin or film rests upon the support at all times. The skin itself may hereby also be used as elastic element.

According to an advantageous embodiment of the invention, the afore-mentioned bracket may be made of at least two parts, with a movable coupling unit being provided between both bracket parts in order to enable a relative movement (travel, pivoting) of both bracket parts relative to one another. Such a relative movement may be implemented in the form of a pivoting or a displacement. Both bracket parts should, of course, be fixed to one another, when the weakening operation—i.e. the cutting—is executed.

To establish a cutting effect, cutting knife and film or skin must be moved in relation to one another. Either the cutting knife alone, or the film or the skin alone, or both elements simultaneously may hereby be moved relative to one another.

The second basic embodiment, unlike the rigid connection of cutting knife and support, may involve an adjustment of both elements, which optionally may move relative to one another, such that the above-stated predefined residual wall thickness is guaranteed at all times. For this purpose, the position of the support and/or the position of the cutting knife in the cutting axis is to be ascertained. Both positions may be fed to a controller which determines here from the distance between the tip of the cutting knife and the support. In response to this signal, a drive can be activated either for the cutting knife or the support or possibly also for both devices so that the distance to realize a desired residual wall thickness can be reliably adjusted by a control process. Again, the fixed distance in prolongation of the cutting axis is a characterizing feature here.

In order to introduce randomly configured weakening lines in a material, it may be advantageous to construct the cutting knife for rotation about its cutting axis. In this case, the cutting knife can always be adjusted in the desired manner to implement an optimum cut, when a change in direction between cutting knife and workpiece occurs. The bracket can in this case held in a fixed rotative position independent from the rotation of the tool or the axis 6 through intervention of a freewheel and a torque support on the robot's wrist joint. In this case, the abutment is to be configured as movable sphere to render possible a movement in cutting direction of the knife. The bracket can be held by this measure in a position which permits an optimum access to the workpiece.

Of course, an additional rotary drive (e.g. as external robot axis) may hereby be provided for rotating the cutting knife and controlled in correspondence to the change in direction. It is also possible, to substitute the torque support and the sphere by a moving roll which is mounted onto an additional and synchronized rotary drive.

A further embodiment is characterized by providing the cutting knife, disposed in opposition to the support, with an integral tracer which moves back against a stop, when a skin or film is deposited, and moves into contact against the cutting knife in the absence of a skin or film. The range of movement between the two just described positions is ascertained by a sensor. This embodiment is especially of interest, when damage to the forward tip of the cutting knife is intended to be determined. In the event, the tip of the cutting knife has for example broken off, the range of movement would exceed the desired residual wall thickness so that the deviation allows inference of either a faulty control or damaged cutting knife.

Several exemplary embodiments of the invention will now be described in greater detail with reference to the attached drawings. The drawings show in:

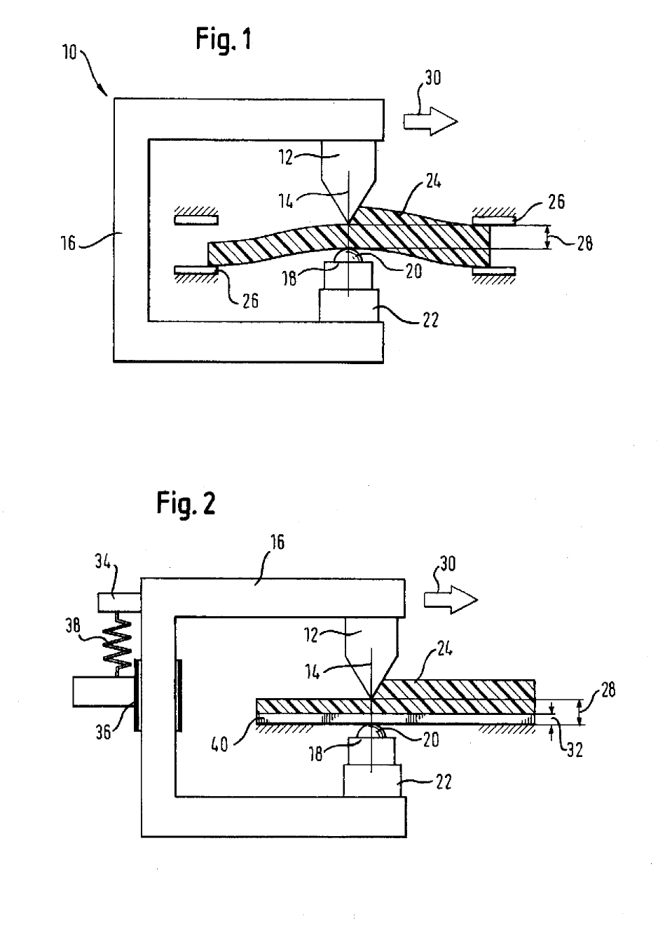

FIG. 1 a schematic side view of a first embodiment of a cutting tool according to the invention,

FIG. 2 a schematic side view of a second embodiment of a cutting tool according to the invention,

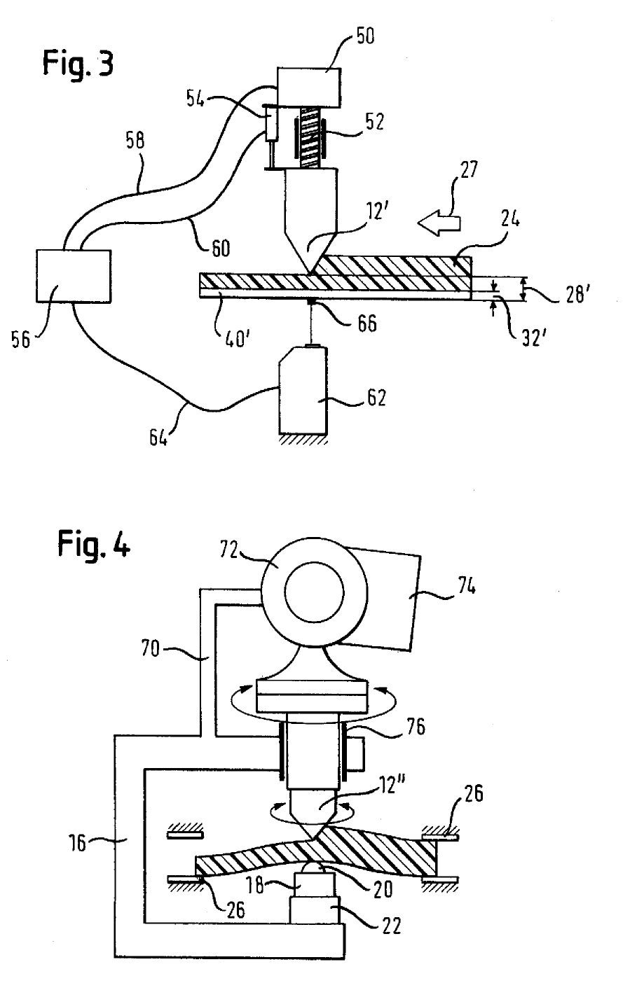

FIG. 3 a schematic illustration of a third embodiment of a cutting tool according to the invention,

FIG. 4 a schematic illustration of a fourth embodiment of a cutting tool according to the invention,

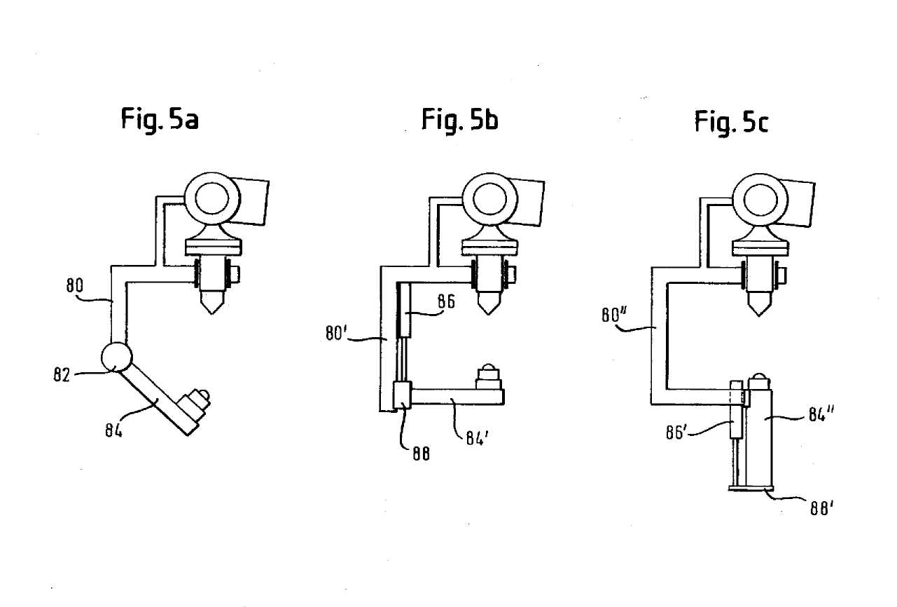

FIGS. 5a to 5c various schematic illustrations, depicting respectively a multipart openable and closeable bracket of a cutting tool according to the invention,

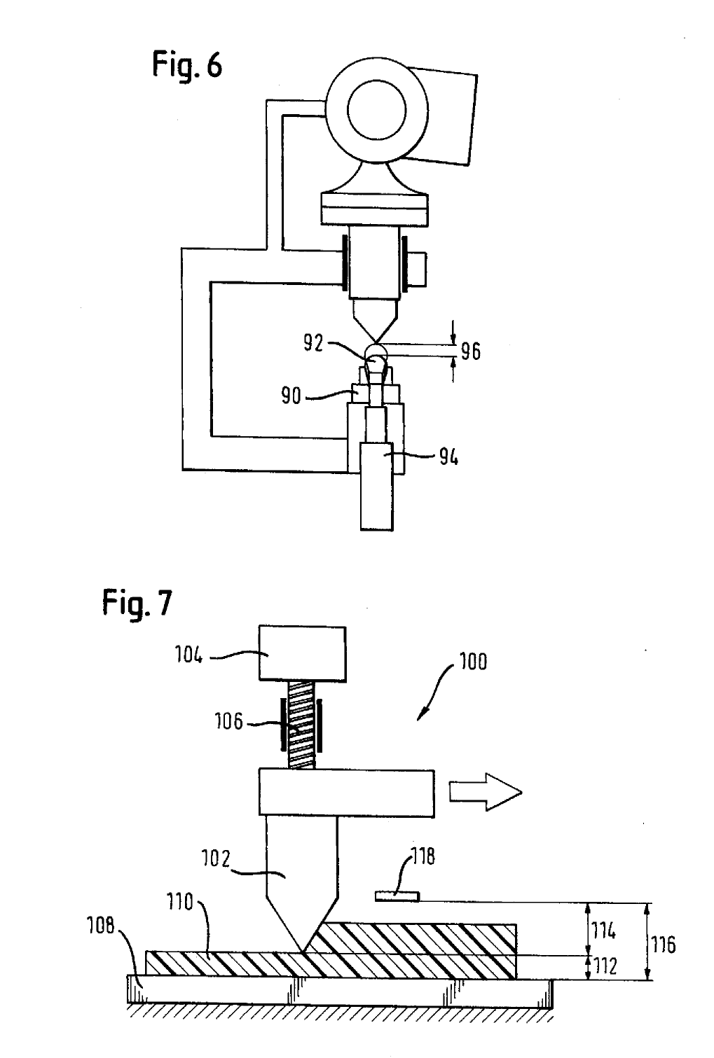

FIG. 6 a schematic illustration of a cutting tool according to the invention with a tracer, and

FIG. 7 a schematic illustration of a prior art cutting tool.

FIG. 1 shows a schematic illustration of a cutting tool 10 for weakening of plastic skins and similar workpieces. A plastic skin 24 (hereinafter also called workpiece) is securely held between two clamping devices 26. The cutting tool 10 includes a cutting knife 12 and—in prolongation of the cutting axis 14—an abutment 18 which assumes in this embodiment also the function of a support. The abutment 18 is held in the housing of a load cell 22 which can determine the pressure upon the abutment 18. Hereinafter, the term support relates in general to any device which directly supports the workpiece.

The cutting tool 12 and the load cell 22 are rigidly connected to one another via a U-shaped bracket 16. In this context, it is to be noted that the abutment 18 does not shift in relation to the bracket 16 and along the cutting axis 14 so that the distance between the abutment 18 and the tip of the cutting tool 12 is always the same. This distance 28 corresponds to the later residual wall thickness. A sphere 20 is provided at the end of the abutment 18 on a side proximal to the cutting tool and held rotatably.

Not shown in FIG. 1 is the mounting of the cutting tool. In order to be able to move the cutting tool for example in the direction of arrow 30, it is held for example on a robotic apparatus which is able to move the cutting tool at least in one plane. However, basically all movement directions are suitable here in order to be able to move the bracket into the required positions, i.e. in x axis, y axis and z axis.

The mode of operation of this first embodiment of the invention is thus clear and indeed simple. After inserting the workpiece 24 to be weakened in the intermediate space between the cutting tool 12 and the abutment 18 or moving the tool into the work area on the workpiece, the cutting tool 10 is moved in such a way that the workpiece 24 is elastically deformed and supported against the abutment 18—here the sphere 20—with a respective force. The load cell 2 measures the forces and ensures that the workpiece to be weakened continuously bears upon the abutment 18 acting as support. As the rigid unit comprised of cutting tool 12, bracket 16, and abutment 18 moves, the workpiece 24 is cut and weakened to ensure that a residual wall thickness remains in correspondence to a distance defined by the distance between the tip of the cutting knife 12 and the uppermost end of the sphere 20.

A structurally slightly modified embodiment of the invention is shown in FIG. 2 and will be described hereinafter. Same reference signs designate hereby same elements as in FIG. 1. The difference between the embodiments in FIG. 1 and FIG. 2 resides in the disposition of the workpiece 24 to be weakened upon a plate 40—also called support table. This support table assumes the function of the support. The sphere 20 of the abutment 18 now rolls on the lower surface of the support table. A spring 38 extends between an externally secured support block 36 and a support tab 34 of the bracket 16 and maintains the unit of cutting tool 12, bracket 16, and abutment 18 under tension to ensure a contact of the workpiece 24 on the support table 40. This spring 38 urges the sphere 20 against the bottom side of the support table 40, with this force being measured by the load cell 22. The residual wall thickness is governed by the difference of the distance of the cutting knife from the abutment 18 minus the thickness of the support table 40.

A further embodiment of the present invention is also shown schematically in FIG. 3. Shown here are only the relevant elements with respect to adjustment or control. Other elements have been omitted for ease of illustration.

FIG. 3 shows a cutting knife 12′ which is adjustable within certain ranges in the direction of its cutting axis by means of an actuator (e.g. servomotor 50 and spindle drive 52). The position of the cutting knife 12′ is ascertained by means of a distance sensor. The sensor 54 is connected via a signal line 60 with a controller 56. The controller 56 has further a control line 58 to the servomotor 50 to receive the respective control signals.

In addition, a further distance sensor 52 is arranged underneath the support table 40 and determines the distance to a measuring point 66 by means of a tracer. The measuring point is hereby located at the intersection of the cutting axis with the bottom side of the support table 40′. This distance information is also fed to the controller 56 via a signal line 64.

The controller 56 is able to determine from both signals of the distance sensors 54 and 62, when suitably calibrated, the distance between the tip of the cutting knife 12′ and the measuring point 66, which is arranged in the direction of the cutting axis on the bottom side of the support table 40′, and to readjust the knife position via the servomotor in dependence on the desired distance. The residual wall thickness is again governed by the distance between the cutting knife 12′ and the measuring point 66 minus the thickness of the support table 32′.

The advantage of this surely more complex apparatus is the adjustability of the residual wall thickness. It is further possible to use support tables with variable or unknown thickness. The cutting knife is hereby first replaced by a distance sensor and then the thickness profile is determined by a one-time reference run in response to the movement. These reference data are stored and used together with an optionally variable desired residual wall thickness during the later cutting operation as desired value.

In the embodiment of FIG. 3, the support table 40′ is moved with the skin positioned thereon along the arrow 27. The controller 56 then determines continuously and in dependence on the signals of the distance sensors 54 and 62 the control signal for the servomotor 50. Also in this way, it is possible to ensure a defined residual wall thickness through respective supervision upon the cutting axis, even though there is no rigid connection between the cutting knife 12′ and a support (here the support table 40′).

The embodiment illustrated in FIG. 4 corresponds substantially to the embodiment illustrated in FIG. 1. However, the bracket is now supported for rotation about the knife pivot axis 76. The bracket is supported on the robot wrist joint 72 via a torque support 70 so as to maintain its position independent from a knife rotation. As a result of the rotatability of the cutting knife 12′, a reliable cut can be executed along any cutting line. The cutting knife 12′ is respectively rotated in response to any change in direction so as to attain an optimal cutting result.

Of particular interest is also the easy accessibility of the workpiece by the cutting tool. FIGS. 5a to 5c show three different embodiments which permit a respective insertion of the tool without any problem in the presence of a rigid coupling—at least during the cutting operation—between cutting knife and support.

In the first embodiment according to FIG. 5a, the U-shaped bracket is made of two parts, that is with a first upper angular region 80 and a leg 84 which are connected to one another via a hinge. An abutment is arranged on the hinge-distal end of the leg 84. As the leg 84 is pivoted in relation to the angular part 80 of the bracket, the receiving space is opened so that a skin element can easily be deposited. After placement of the skin element or insertion into a workpiece, the U-shaped bracket can be closed as the leg 84 is moved upwards. Of course, the two different elements of the U-shaped bracket must be fixed relative to one another during the actual treatment operation.

FIG. 5b shows a further embodiment for placement of a skin part, whereby the angular part 80′ of the bracket is no longer connected anymore with the leg 84′ by a joint. Rather, the leg 84′ is now held by a respective guide on the other bracket part 80′ for linear movement. The linear movement and the securement of both elements is implemented by a hydraulic cylinder 86 which is supported on one side on the bracket part 80′ and on the other side on the bracket part 84′. As an alternative, the actuator may, of course, also be configured as pneumatic or electric drive.

A further exemplary embodiment to ensure a reliable insertion or placement is shown in FIG. 5c. Compared to the embodiment in 5b, the lower leg 85′ is now lowered not its entirety but only the abutment 84′. The U-shaped bracket remains thus substantially rigid.

A final embodiment of the invention is shown in FIG. 6. Reference is made only to the abutment 92 serving as support. This abutment is constructed at the same time with a measuring head and has a connection with a measuring tracer 94. When the skin (not shown in FIG. 6) is inserted, the measuring head 92 is shifted downwards against a stop and thus spaced at a distance from the tip of the cutting knife in correspondence with the residual wall thickness. When the skin is removed however, the measuring head 92 can advance in the direction of the cutting knife, with the movement being ascertained by the measuring tracer 94. In this way, the distance of the support to the cutting tool can be determined. When this distance does not correspond to the desired residual wall thickness, then either the adjustment is faulty or the cutting knife has been damaged in the area of the tip.

In summary, the cutting tool or the cutting knife and the abutment or the support are coupled to one another (passively or actively) such that the distance between both elements is precisely defined. The abutment thus establishes the movement of the cutting tool and thus the cutting depth directly on the cutting axis, when the workpiece rests upon the abutment. The use of a “virtual abutment” which determines the position of the residual wall thickness by means of a contactless operating sensor is also covered by the scope of the invention. This is true even when the residual wall thickness of the workpiece is not used directly as counterpiece, whereby instead the distal apparatus side and residual wall side of the workpiece are either known by the manufacturing specifications of the apparatus or determined with a reference run.

Tolerances of a robot movement are compensated with the assistance of an active or passive compensating element which maintains the relative position between tool and abutment in the direction of the cutting axis at a defined parameter through movement of the workpiece, the workpiece-abutment unit and/or a synchronized individual movement of tool and abutment. The contact between abutment and residual wall thickness of the workpiece can be monitored by an integrated sensor assembly (force sensors, precision sensors, distance sensors).

In summary, the process can be carried out by guiding the tool or the workpiece. In other words, the tool can be guided or held stationary. Any mechanical cutting tool can be used as tools, such as a blade, a milling cutter with spindle, ultrasonic knife, hot knife, perforation tool (e.g. oscillating needle), etc.

An active coupling between abutment and tool can be realized by the use of any electric, pneumatic, mechanic, or hydraulic actuators, or combinations thereof.

A direct mechanic coupling between tool and abutment can use external robot axes in order to keep the bracket away from a collision range. Moreover, when a variant is involved in which the tool is guided, the bracket can be mechanically suited to the robot in such a way that its position is independent from the axis of the robot to enable optimum access to the work area. The use of rotation-symmetric tools allows in addition the use of a bracket in an optimal position

As described above, optimal accessibility should also be ensured to the tool.

The present invention provides high process reliability for weakening of plastic skins or similar workpieces, such as films etc. through one-sided cutting because a defined distance between a support and the tip of a cutting tool is ensured in the direction of the cutting axis.

### LIST OF REFERENCE SIGNS

10 cutting tool
12, 12′ cutting knife (partially rotatable)
12″
14 cutting axis
16 bracket
18 abutment
20 sphere
22 load cell
24 (workpiece (to be weakened)
26 clamping apparatus
28, 28′ residual wall thickness
30 movement direction
32, 32′ thickness of support table
34 support tab
36 support block
38 helical spring
40, 40′ support table
50 servomotor
52 spindle drive
54 distance sensor for cutting knife
56 controller
58 control line to servomotor
60 signal line from distance sensor
62 distance sensor for support table
64 signal line from support table
66 measuring point
70 restraining arm
72 joint
74 robot arm
76 rotary mounting
80, 80′ restraining bracket (first part)
80″
82 joint
84, 84′ restraining bracket (second part) or abutment
84″
86, 86′ hydraulic cylinder
88, 88′ support for the hydraulic cylinder (moving)
90 load cell
92 counter support
94 measuring tracer
96 cutting gap
100 cutting tool (prior art)
102 cutting knife
104 servomotor
106 adjustment spindle
108 support table
110 workpiece (to be weakened)
112 residual wall thickness
114 reference thickness
116 sensor signal
118 distance sensor

1.-12. (canceled)

13. Apparatus for introducing a weakening cut in a film or skin, comprising:
a cutting knife;
a support arranged in opposition to the cutting knife for support of a film or skin arranged between the support and the cutting knife, with the cutting knife being configured for movement in relation to the film or skin along a cutting axis; and
a device maintaining a distance between the cutting knife and the support constant in a direction of the cutting axis.

14. The apparatus of claim 13, further comprising a mechanical coupling between the cutting knife and the support.

15. The apparatus of claim 14, wherein the mechanical coupling is constructed rigid between cutting knife and support.

16. The apparatus of claim 13, further comprising an elastic device for maintaining the cutting knife and the support under tension to thereby ensure a reliable placement of the skin or film upon the support.

17. The apparatus of claim 14, wherein the mechanical coupling is implemented by a bracket having a clearance to embrace the film or skin.

18. The apparatus of claim 17, wherein the bracket is made of at least two parts, and further comprising a movement device acting between the two bracket parts to move the two bracket parts in relation to one another.

19. The apparatus of claim 18, wherein the movement device pivots the two bracket parts in relation to one another.

20. The apparatus of claim 13, further comprising a movement apparatus engaging indirectly or directly the cutting knife to move the cutting knife and thereby allow a relative movement of film or skin and cutting knife.

21. The apparatus of claim 13, further comprising a movement apparatus engaging indirectly or directly the skin or the film or a mounting for the skin or the film to move the skin or film and thereby allow a relative movement of film or skin and cutting knife.

22. The apparatus of claim 13, further comprising:
a first sensor generating a first signal representative of a position of the support in the cutting axis,
a second sensor generating a second signal representative of a position of the cutting knife in the cutting axis,
a controller to receive the first and second signals, said controller configured for generating an adjustment signal in dependence on the first and second signals to ascertain the position of the cutting knife and the position of the support, and
an adjustment drive to adjust the position of the cutting knife in the cutting axis in response to the adjustment signal from the controller.

23. The apparatus of claim 13, wherein the cutting knife is constructed for rotation about its cutting axis.

24. The apparatus of claim 13, further comprising a rotary drive for rotating the cutting knife.

25. The apparatus of claim 13, wherein the support in opposition to the cutting knife includes an integral tracer which is movable backwards against a stop, when the skin or foil is deposited, and movable into contact upon the cutting knife in the absence of the skin or film, with a movement range being determined by means of a sensor.
